(19) United States
(12) Patent Application Publication
(10) Pub. No.: US 2009/0235337 A1
(43) Pub. Date: Sep. 17, 2009

(54) Method and device for identification of a communication party

(76) Inventors: Peter Holm, Sollentuna (SE); Anders Thoursie, Nacka (SE); Sven-Hakan Olsson, Stockholm (SE)

Correspondence Address: HARNESS, DICKEY & PIERCE, P.L.C., P.O. BOX 8910, RESTON, VA, 20195, US

(21) Appl. No.: 11/918,900

(22) PCT Filed: Apr. 20, 2005
(86) PCT No.: PCT/SE2005/000569

§ 371 Date: Mar. 10, 2009

(51) Int. Cl. H04L 9/32; H04M 3/42; H04M 1/66

(52) U.S. Cl. 726/5; 379/201.02; 455/411

(57) ABSTRACT

A method and a system are disclosed for identifying a registrant. In at least one embodiment of the present application, a telephone communication address is received from the registrant, and personal information associated with the telephone communication address is obtained from a storage. The association of the personal information and the telephone communication address in the storage is of such a nature that it enables usage of the personal information to get in contact with the person controlling the associated telephone communication address. A first confirmation token is then distributed over a first channel to the registrant and a second confirmation token is received from the registrant over a second channel, and at least one of the first and the second channel is established by way of using the telephone communication address. Finally, correspondence between the first confirmation token and the second confirmation token is verified.

### TECHNICAL FIELD OF THE INVENTION

The present invention relates to a method for identifying a registrant, which is a communication party for which there is a need to register personal information. The invention further relates to a system for identifying a registrant.

### BACKGROUND ART

These days, companies establish relationships to new customers and other communication parties via the Internet to an ever-increasing extent. In most cases, there is a need to register personal information about the new customers or communication parties, such as name and address. Hence, the new customers or communication parties are here referred to as registrants. The company or person controlling the registered information is referred to as register owner.

Registration of personal information can be done in different ways depending on existing circumstances. In some situations, it may be sufficient for a register owner to allow the registrants to simply register the personal information via the Internet, i.e. when there is no need to further ensure the accuracy of the information. In other situations, this is however crucial; for instance when a customer orders products over the Internet to be paid at a later time, or when a local municipality allows the citizens to fill in forms to apply for various certificates or licenses.

When it is verified that the registered personal information is actually referring to the registrant, the registrant is said to be identified. It is often sufficient to ensure that a set of personal information can be used to get in contact with a specific person. Hence, the person is considered to be identified when this type of assurance is regarded as sufficient and appropriate for the concerned purpose.

A way to ensure the identity of a registrant, in this sense, is to send a letter to a registered address, containing a user name and a password. This procedure ensures that the person in control of the user name and password is a person in control of the physical mail delivered to the registered name at the registered address. This, in turn, is taken as an indication that the name and the address can be used to get in contact with the registrant at a later date and the registrant is then said to be identified. However, this procedure is costly and time-consuming.

There are also methods involving certificates and Public Key Infrastructure (PKI). These are, however, also costly and complicated since they require all registrants to acquire a certificate prior to the registration.

### SUMMARY OF THE INVENTION

An object of the invention is to alleviate the problems of prior art and to provide a straightforward and easy-to-use method and system of identifying a registrant.

This object is accomplished by a method for identifying a registrant in accordance with claim 1, and a system for identifying a registrant in accordance with claim 19.

According to a first aspect of the present invention, a method is provided of identifying a registrant, which is a communication party for which there is a need to register personal information. First, a telephone communication address of the registrant is received, and personal information associated with the telephone communication address is acquired from a storage. Then, a first confirmation token is delivered to the registrant over a first channel. A second confirmation token is received over a second channel from the registrant, wherein at least one of the first and the second channel is established by using the telephone communication address. Finally, correspondence between the first confirmation token and the second confirmation token is verified, wherein the registrant is identified and registered.

According to a second aspect of the present invention, a device is provided for identifying a registrant, which is a communication party for which there is a need to register personal information. The device comprises means for receiving a telephone communication address of the registrant, means for acquiring personal information associated with the telephone communication address from a storage and means for delivering a first confirmation token to the registrant over a first channel. Further, the device comprises means for receiving a second confirmation token from the registrant over a second channel, wherein at least one of the first and the second channel is established by using the telephone communication address and means for verifying correspondence between the first confirmation token and the second confirmation token, wherein the registrant is identified and registered.

A basic idea of the present invention is that a telephone communication address is received from a registrant, and personal information associated with the telephone communication address is obtained from a storage. The registrant may for instance be a new customer wishing to access a service provided by a service provider. The telephone communication address may e.g. be received by the service provider by asking the new customer to enter a telephone number in a form on a web site of the service provider. The association of the personal information and the telephone communication address in the storage is of such a nature that it enables usage of the personal information to get in contact with the person controlling the associated telephone communication address. A first confirmation token is then distributed over a first channel to the registrant. This may be effected by establishing a telephone call with the registrant using IP telephony or “regular” telephony, in which call a code—i.e. the first confirmation token—is transferred to the registrant. A second confirmation token is received from the registrant over a second channel, and at least one of the first and the second channel is established by means of using the telephone communication address. For instance, the registrant is asked to state the received code in a form on the web site of the service provider, wherein the second confirmation token in the form of the code is received by the service provider. Finally, correspondence between the first confirmation token and the second confirmation token is verified. In this way it is verified that the registrant is in control of the telephone communication address associated with the registered personal information in the storage. This is regarded as an indication that the personal information can be used to get in contact with the registrant and the registrant is thus considered identified and registered.

In embodiments of the present invention, a public directory service may be queried for receiving the registrant's name and address, which are associated with the telephone number. If the required data cannot be found in the directory, an error message may be returned to the registrant.

Note that the personal information associated with the telephone communication address may refer to a person, a company or an organization. Further note that the steps of identifying the registrant by means of the telephone communication address need not be performed in the order given in the method defined by the claims. However, in the method of the invention, the telephone communication address must first be received before the other steps may be performed.

In an embodiment of the invention, the first confirmation token is distributed over a communication channel that is established using the telephone communication address. If so, the second confirmation token could either be distributed over the same telephone communication channel or over a digital network, which in a further embodiment is the Internet.

In another embodiment, the first confirmation token is distributed over a digital network, which in a further embodiment is the Internet. Then, the second confirmation token must be distributed over a communication channel that is established using the telephone communication address.

A communication channel that is established using the telephone communication address could for instance be an IP telephone communication channel, a “regular” voice telephone communication channel using for example PSTN or GSM (or some other type of mobile phone system) or a combination of the two. The confirmation tokens could then be comprised in e.g. voice messages, SMS, MMS or instant messaging messages.

In yet an embodiment of the invention, the personal information associated with the telephone communication address can be obtained by querying a directory service, the directory service being capable of returning personal information associated with a telephone communication address. Directory services which are internal as well as external to the company are within the scope of the invention.

In a further embodiment, the directory service is a public directory service and the telephone communication address is a telephone number. The public directory service will thus provide the address and name associated with a specific telephone number.

Further features of, and advantages with, the present invention will become apparent when studying the appended claims and the following description. Those skilled in the art realize that different features of the present invention can be combined to create embodiments other than those described in the following.

### BRIEF DESCRIPTION OF THE DRAWINGS

A detailed description of preferred embodiments of the present invention will be given with reference made to the accompanying drawing, in which:

FIG. 1 illustrates the method and device of the present invention.

### DETAILED DESCRIPTION OF PREFERRED EMBODIMENTS OF THE INVENTION

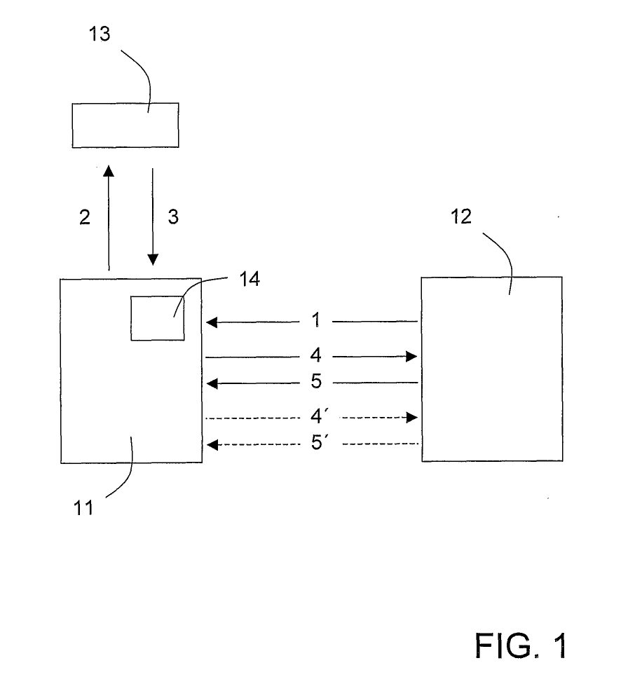

FIG. 1 illustrates how a telephone communication address is received (step 1) by a register owner 11 from a registrant 12. The steps defined in the method of the present invention is typically performed by a computer 14 at the register owner 11, which computer executes appropriate software for performing these steps. The register owner 11 is typically remotely located from the registrant 12, which implies that a network, e.g. the Internet, is used to connect the register owner 11 and the registrant 12. The telephone communication address is then sent (step 2) to a storage 13, typically being a server or some other suitable storage means on which communication information is stored, and personal information associated with the telephone communication address is returned (step 3) to the register owner 11. Note that the storage 13 may be remote from the register owner 11, but may alternatively be integrated with the register owner, for example in the form of a memory which is directly accessible by the computer 14.

A first confirmation token is distributed (step 4) to the registrant 12 over a first communication channel and a second confirmation token is received (step 5) by the register owner 11 over a second communication channel. The tokens are compared, and a check for correspondence between the two tokens is thus performed. The delivery of the first token and the reception of the second token are typically performed via an appropriate interface controlled by the computer 14, or the software the computer is executing.

An example of the environment in which the present invention may be applied is given in the following.

Consider an Internet application, in which citizens 12 can apply for licenses of various sort at a municipality 11. When an application form is submitted, there is a need to register the name and address of the applicant, i.e. the citizen 12. There is also a need to verify the accuracy of the registered name and address.

When submitting (step 1) the form, the applicant 12 is asked to state a telephone number currently available to the applicant. The municipality 11 then sends (step 2) a request to a public directory service 13 to receive the name and address associated with the telephone number. Should no personal information be available for this particular telephone number, an error code may optionally be generated at the municipality 11. The applicant is informed about this and is asked to submit a different telephone number (step 4′), which the applicant preferably transfers to the municipality (step 5′). When there is no error code, the name and address associated with the telephone number is submitted (step 3) from the public directory service 13 to the municipality 11, and a first confirmation token is distributed to the applicant through a telephone call to that telephone number. The call is initiated (step 4) and the first token is read to the applicant 12. The applicant 12 then registers (step 5) a second token in a form in the Internet application. If the second token is found to be the same as the first token read to the applicant during the telephone call, the name and address are registered at the municipality.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method for identifying a registrant, which is a communication party for which there is a need to register personal information, said method comprising:
receiving a telephone communication address of the registrant;
acquiring, from a storage, personal information associated with the telephone communication address;
delivering, over a first channel, a first confirmation token to the registrant;
receiving, over a second channel, a second confirmation token from the registrant, wherein at least one of the first and the second channel is established by using the telephone communication address; and
verifying correspondence between the first confirmation token and the second confirmation token, wherein the registrant is identified and registered.

2. The method according to claim 1, further comprising: establishing the first channel by using the telephone communication address.

3. The method according to claim 1, further comprising: establishing the second channel by using the telephone communication address.

4. The method according to claim 1, wherein the step of acquiring personal information further comprises: generating an error code if no personal information is available in the storage.

5. The method according to claim 4, further comprising: requesting the applicant to state a different telephone communication address, if the acquiring personal information from the storage results in an error code being generated for the telephone communication address.

6. The method according to claim 1, wherein the telephone communication address is received through a digital network.

7. The method according to claim 6, wherein the digital network is the Internet.

8. The method according to claim 1, wherein the first communication channel is comprised in at least one of a public switched telephone network, a mobile telephone network, and an IP telephone network.

9. The method according to claim 1, wherein the second communication channel is comprised in at least one of a public switched telephone network, a mobile telephone network, and an IP telephone network.

10. The method according to claim 1, wherein the first communication channel is established via the Internet.

11. The method according to claim 1, wherein the second communication channel is established via the Internet.

12. The method according to claim 1, wherein the first confirmation token is delivered as a voice message.

13. The method according to claim 1, wherein the second confirmation token is received as a voice message.

14. The method according to claim 1, wherein the first confirmation token is delivered as at least one of an SMS message, an MMS message and an instant messaging message.

15. The method according to claim 1, wherein the second confirmation token is received as at least one of an SMS message, an MMS message and an instant messaging message.

16. The method according to claim 1, wherein the acquiring of the personal information is performed by querying a directory service.

17. The method according to claim 1, wherein the acquiring of the personal information is performed by querying a public directory service.

18. The method according to claim 1, wherein the acquiring of the personal information associated with the telephone communication address enables contacting a user of the telephone communication address.

19. A device for identifying a registrant, which is a communication party for which there is a need to register personal information, said device comprising:
means for receiving a telephone communication address of the registrant;
means for acquiring from a storage, personal information associated with the telephone communication address;
means for delivering, over a first channel, a first confirmation token to the registrant;
means for receiving, over a second channel, a second confirmation token from the registrant, wherein at least one of the first and the second channel is established by using the telephone communication address; and
means for verifying correspondence between the first confirmation token and the second confirmation token, wherein the registrant is identified and registered.

20. The device according to claim 19, further comprising: means for establishing the first channel by using the telephone communication address.

21. The device according to claim 19, further comprising: means for establishing the second channel by using the telephone communication address.

22. The device according to claim 19, wherein the means for acquiring personal information further comprises means for generating an error code if no personal information is available in the storage.

23. The device according to claim 22, further comprising: means for requesting the applicant to state a different telephone communication address, if the acquiring of personal information from the storage results in an error code being generated for the telephone communication address.

24. The device according to claim 19, wherein the means for receiving a telephone communication address of the registrant is arranged to receive the telephone communication address via a digital network.

25. The device according to claim 24, wherein the digital network is the Internet.

26. The device according to claim 19, wherein the first communication channel is arranged to be comprised in at least one of a public switched telephone network, a mobile telephone network, and an IP telephone network.

27. The device according to claim 19, wherein the second communication channel is arranged to be comprised in at least one of a public switched telephone network, a mobile telephone network, and an IP telephone network.

28. The device according to claim 19, wherein the first communication channel is arranged to be established via the Internet.

29. The device according to claim 19, wherein the second communication channel is established via the Internet.

30. The device according to claim 19, wherein the means for delivering a first confirmation token to the registrant is arranged to deliver the first confirmation token as a voice message.

31. The device according to claim 19, wherein the means for receiving a second confirmation token from the registrant is arranged to receive the second confirmation token as a voice message.

32. The device according to claim 19, wherein the means for delivering a first confirmation token to the registrant is arranged to deliver the first confirmation token as at least one of an SMS message, an MMS message and an instant messaging message.

33. The device according to claim 19, wherein the means for receiving a second confirmation token from the registrant is arranged to receive the second confirmation token as at least one of an SMS message, an MMS message and an instant messaging message.

34. The device according to claim 19, wherein the means for acquiring the personal information is arranged to acquire the information by querying a directory service.

35. The device according to claim 19, wherein the means for acquiring the personal information is arranged to acquire the information by querying a public directory service.

36. The device according to claim 19, wherein the means for acquiring the personal information associated with the telephone communication address is arranged to contact a user of the telephone communication address by means of the personal information.

37. A computer program product comprising computer-executable components for causing a device to perform the method of claim 1 when the computer-executable components are run on a processing unit included in the device.
